(19) United States
(12) Patent Application Publication
(10) Pub. No.: US 2003/0127950 A1
(43) Pub. Date: Jul. 10, 2003

(54) Mail opening bag for preventing infection of bacteria-by-mail

(76) Inventors: Cheng-Hui Tseng, Tainan City (TW); Jin-Ming Chen, Tainan City (TW)

Correspondence Address: CHARLES E. BAXLEY, ESQUIRE, Hart, Baxley, Daniels & Holton, 59 John St, 5Fl, New York, NY, 10038, US

(21) Appl. No.: 10/042,013

(22) Filed: Jan. 10, 2002

(51) Int. Cl. A61G 11/00

(52) U.S. Cl. 312/1

(57) ABSTRACT

A mail opening bag for preventing infection of bacteria-by-mail includes a containing body, and a pair of gloves. The containing body has an opening, a transparent upper part, and sealing elements for sealing the opening. The gloves are received in the containing body, and are formed together with the containing body with the wrist portions thereof being connected to the containing body. The gloves have coarse surfaces at the fingertip portions for increasing the friction against a mail to be opened in the containing body. Thus, a user can be sure whether there is suspicious powder when opening mail in the mail opening bag, and protected against possible infection.

### BACKGROUND OF THE INVENTION

The present invention relates to a mail opening bag, which provides a tightly closed room for a suspicious mail to be received, and opened therein such that any bacteria such as anthrax that might be contained in the mail can't contact or infect the person opening the mail.

There have been conflicts, and misunderstanding between countries, tribes, and people of different religions probably since men began to live in this world. And, the terrorists, especially those from Middle East, make the situations become a lot worse in light of the fact that they use bombs, hightjack and so on to cause fear and casualties in their targeted areas and countries. Consequently, most of the vicitims are civilians. Recently, after 911 airplane attack, anthrax-by-mail, whatever the source is, has been causing a few casualties and much scare among people, especially mail handlers who have to deal with a lot of mails each day.

Although, electronic equipments are adopted to decontaminate the mails by the postal service such that any bacteria that is put into the mails by the criminals can't infect the mail handlers or the addressees any more, the addressees probably are still scared of opening a mail.

If people have additional precautionary measures, the scare and danger of opening a mail would be reduced to a large degree.

### SUMMARY OF THE INVENTION

Therefore, it is a main object of the present invention to provide a mail opening bag such that a mail can be opened while received in the bag, thus eliminating the scare of getting infected and preventing infection if there are bacteria contained in the mail.

The mail opening bag of the present invention includes a containing body, and a pair of gloves. The containing body has an opening for allowing a mail to be put thereinto, and a transparent upper part for objects received therein to be clearly seen; the containing body has sealing elements fitted thereto for sealing the opening.

The gloves are received in the containing body, and are formed together with the containing body with wrist parts thereof being connected to the containing body; the wrist parts each having an opening for allowing a user's hands to pass into the gloves; the gloves having coarse surfaces at fingertip portions thereof for increasing friction of the fingertip portions against a mail to be opened in the containing body;

Thus, a mail can be contained and opened in the containing body by means of the fingertip portions of the gloves with the sealing elements being connected together to seal the opening.

### BRIEF DESCRIPTION OF THE DRAWINGS

The invention can be better understood by reading the following detailed description of the preferred embodiments, with reference made to the accompanying drawings, wherein:

FIG. 1 is a perspective view of the mail opening bag for preventing infection of bacteria-by-mail according to the present invention,

FIG. 2 is a perspective view of the mail opening bag of the second embodiment of the present invention,

FIG. 3 is a fragmentary cross-sectional view of the containing body of the mail opening bag of the present invention; and,

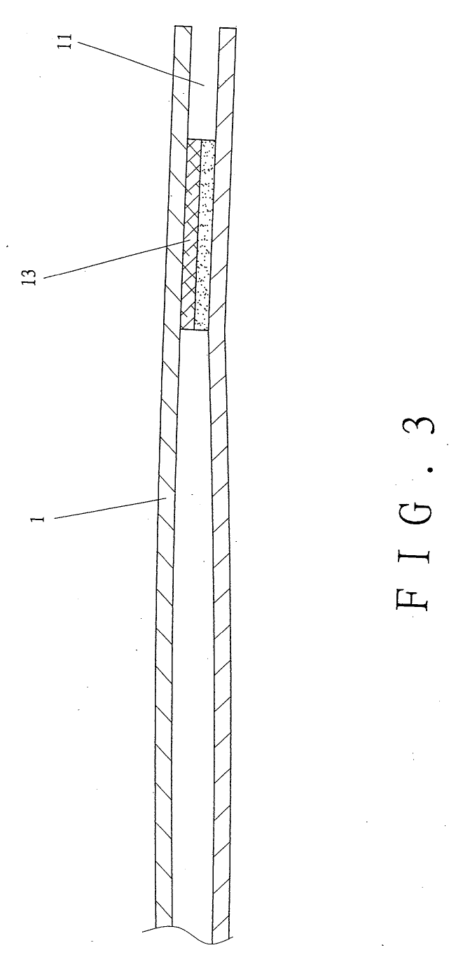

FIG. 4 is a view illustrating the way of using the mail opening bag of the present invention.

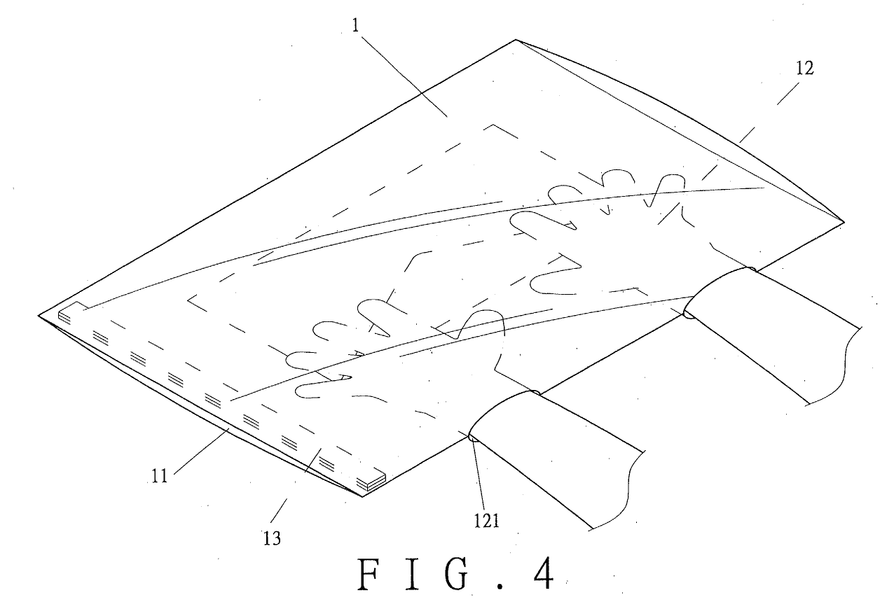

### DETAILED DESCRIPTION OF THE PREFERRED EMBODIMENTS

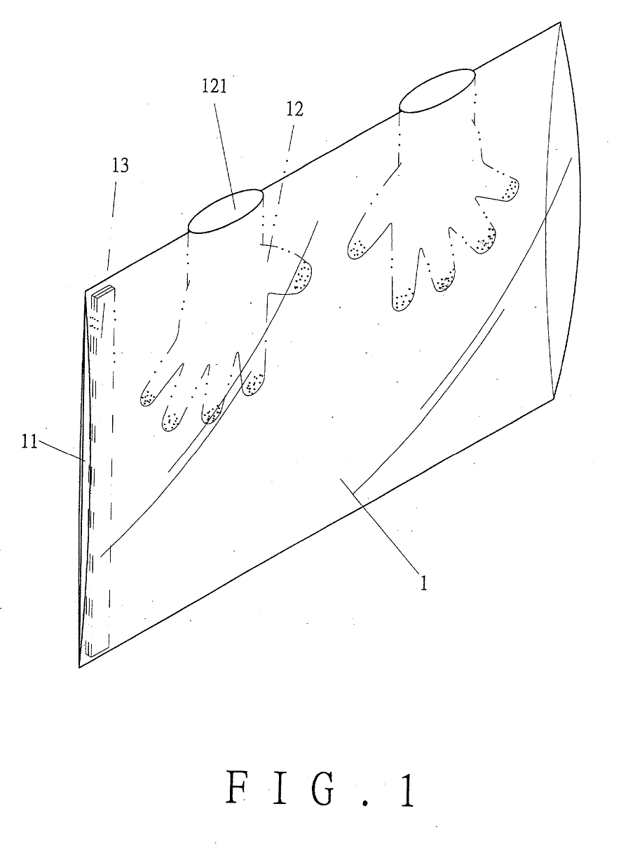

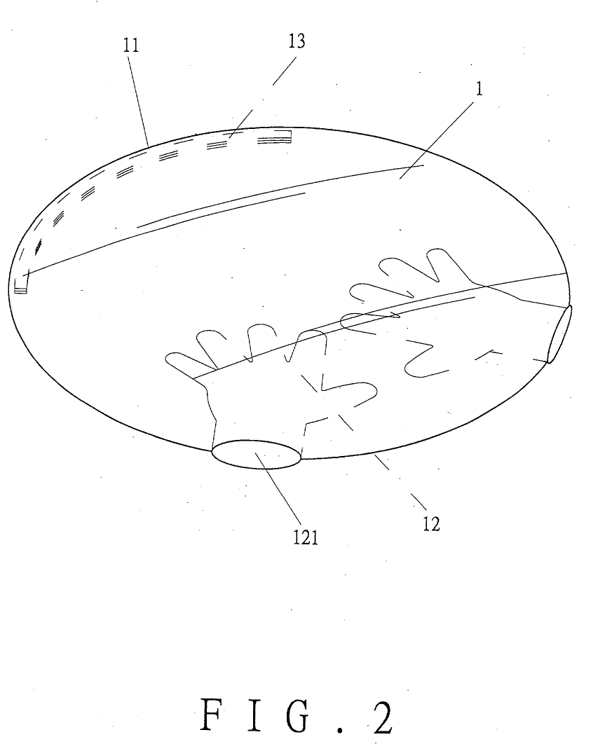

Referring to FIGS. 1, 2,3 and 4, a mail opening bag for preventing infection of bacteria-by-mail according to the present invention includes a containing body 1, and a pair of gloves 12. The containing body 1 is made of plastic materials that are not easily broken and don't allow air to travel through. The upper part of the containing body 1 is transparent. The containing body 1 has an opening 11 on one edge, and sealing elements 13 are fitted to the inner sides of the edge for sealing the opening 11; the sealing elements 13 can be adhesive tapes, zippers and so on as long as they can prevent air from traveling through when they are used.

The gloves 12 are formed together with the containing body 1 to be an integral part of the bag, and each includes an opening 121 at the part for the wrist, and coarse surfaces 122 at the parts for the fingertips; the gloves 12 are mainly received in the containing body 1 except for the parts around the openings 121, which slightly stick out from the edge of the containing body 1; the course surfaces 122 help increase the friction of the fingertip parts against the mail to make the opening of the mail easier.

In using the mail opening bag of the present invention, a mail is put into the containing body 1 from the opening 11, and the sealing elements 13 are connected together to prevent air and bacteria from traveling through the opening 11. Then, the user inserts his/her hands into the gloves 12, and opens the mail received in the containing body 1.

The containing body 1 can be made to have various shapes; referring to FIG. 2, the containing body 1 is circular. In addition, in order for the user to clearly see the objects in the containing body 1, including while powder that might contain bacteria, the bottom part of the containgin body 1 can be formed with deep colors.

From the above description, it can be understood that a mail can be opened safely in the bag, and the person opening the mail with the bag can't be infected because he/she can see clearly if there is bacteria-containing powder coming out of the mail.

The foregoing detailed description is given for clearness of understanding only and no unnecessary limitations should be understood therefrom as modifications will be obvious to those skilled in the art.

What is claimed is:

1. A mail opening bag for preventing infection of bacteria-by-mail, comprising:
a containing body having an opening for allowing a mail to be put thereinto, and a transparent upper part for objects received therein to be seen; said containing body having sealing elements fitted thereto for sealing said opening; and,
a pair of gloves received in said containing body; said gloves being formed together with said containing body with wrist parts thereof being connected to said containing body; said wrist parts each having an opening for allowing a user's hands to pass into said gloves; said gloves having coarse surfaces at fingertip portions thereof for increasing friction of said fingertip portions against a mail to be opened in said containing body;
whereby a mail can be contained and opened in said containing body by means of said fingertip portions of said gloves with said sealing elements being connected together to seal said opening.
